(19) United States
(12) Patent Application Publication
(10) Pub. No.: US 2016/0281785 A1
(43) Pub. Date: Sep. 29, 2016

(54) DEVICE AND METHOD FOR SETTING A BEARING

(71) Applicant: AMARILLO GEAR COMPANY LLC, Amarillo, TX (US)

(72) Inventors: John S. Campbell, Canyon, TX (US); Craig Burriss, Amarillo, TX (US)

(21) Appl. No.: 14/666,206

(22) Filed: Mar. 23, 2015

(51) Int. Cl. F16C 35/067

(52) U.S. Cl. CPC F16C 35/067

(57) ABSTRACT

A method of setting a bearing within a housing and a bearing cavity is disclosed. The method includes threadably advancing a threaded bushing by rotating the threaded bushing in a first rotational direction and identifying a point of contact when the threaded bushing initially contacts the bearing. Subsequently, the threaded bushing is rotated in the first rotational direction by a first predetermined rotational amount to further threadably advance in the first rotational direction so that the threaded bushing exerts a target preload on the bearing, or the threaded bushing is rotated in a second rotational direction by a second predetermined rotational amount to threadably advance the threaded bushing in a second axial direction that is opposite the first axial direction to create a target clearance between the threaded bushing and the bearing, or the threaded bushing is not further rotated to cause line-contact between the threaded bushing and the bearing.

### FIELD OF THE DISCLOSURE

The present disclosure relates to devices and methods for setting a bearing within a housing and, more particularly, to a device and method of setting a clearance and/or a preload associated with a bearing.

### BACKGROUND

Rolling-element bearings are used in many applications to rotationally support a shaft or other rotational member. Rolling-element bearings tend to have an inherent degree of play or internal clearance between their rolling element(s) and their inner and/or outer races. The internal clearance can be a factor in noise creation, vibration, heat build-up and/or fatigue life. To decrease the amount of internal clearance, a common practice is to preload the bearing. Preloading involves applying a compressive force to deform the bearing and thereby reduce the amount of internal clearance. The amount of compression is typically very small (e.g., approximately a few thousandths of an inch) and thus requires that the preloading procedure is performed in a relatively precise manner. In high-temperature applications, instead of preloading the bearing, it is sometimes preferred to provide the bearing with endplay or clearance so that the bearing can thermally expand during operation. The process of imparting the bearing with preload or clearance is commonly referred to as setting the bearing.

To aid technicians and other assembly personnel tasked with having to set the bearing, a shim-and-cap arrangement is sometimes used. The cap typically includes a plate that is bolted to the gearbox housing. To load the bearing, one or more shims (i.e., thin, ring-shaped members) are inserted into a joint between the gearbox housing and the cap, and then the cap is bolted in place to compress the shims. The amount of preload applied to the bearing is dependent upon the number and thickness of the shims in the joint. The shims are relatively thin so that the axial preload can be controlled in small increments. The total thickness of the shims is inversely related to the amount of preload applied to the bearing. In applications where it is desired to provide the bearing with clearance, shims may be added to create the necessary clearance between the bearing and the cap.

Use of a shim-and-cap arrangement to set bearings tends to be time-consuming and cumbersome. Also, it requires the technician and/or operator to keep a supply of shims in the event that the amount of preload or clearance requires adjustment. Furthermore, a technician may have to disassemble and re-assemble the joint formed by the cap and gearbox housing multiple times, with different numbers and thicknesses of shims, in order to determine how many are needed to meet the desired preload or clearance. This iterative assembly technique can make field adjustment of the preload or clearance impractical in some applications.

### SUMMARY

One aspect of the present disclosure includes a method of assembling a bearing within a housing having a threaded opening and a bearing cavity in a manner that preloads the bearing. The method includes positioning the bearing within the bearing cavity and advancing a threaded bushing in an axial direction into the threaded opening of the housing by rotating the threaded bushing in a first rotational direction such that a flange portion of the threaded bushing extends at least partly into the bearing cavity. The method additionally includes identifying a point of contact when the flange portion of the threaded bushing initially contacts the bearing in the bearing cavity. The method further includes rotating the threaded bushing in the first rotational direction by a predetermined rotational amount to further advance the threaded bushing in the axial direction a predetermined axial distance beyond the point of contact so that the flange portion of the threaded bushing exerts a target preload on the bearing.

Another aspect of the present disclosure provides a method of assembling a bearing within a housing having a threaded opening and a bearing cavity in a manner that provides the bearing with clearance. The method includes positioning the bearing within the bearing cavity and advancing a threaded bushing in a first axial direction into the threaded opening of the housing by rotating the threaded bushing in a first rotational direction such that a flange portion of the threaded bushing extends at least partly into the bearing cavity. The method additionally includes identifying a point of contact when the flange portion of the threaded bushing initially contacts the bearing in the bearing cavity. The method further includes rotating the threaded bushing in a second rotational direction that is opposite the first rotational direction by a predetermined rotational amount to advance the threaded bushing in a second axial direction that is opposite the first axial direction a predetermined axial distance away from the point of contact to thereby create a target clearance between an axial end surface of the threaded bushing and an axial end surface of the flange portion of the bearing.

Yet another aspect of the present disclosure provides a method of setting a bearing within a bearing cavity of a gear box housing that defines a gear box cavity containing a gear set, the housing having an opening in communication with the bearing cavity, the bearing cavity being positioned between the opening and the gear box cavity. The method includes advancing a threaded bushing in a first axial direction toward the gear box cavity by rotating the threaded bushing in a first rotational direction until reaching a point of contact between an axial end surface of a flange portion of the threaded bushing and the bearing. After reaching the point of contact, the method includes either: (i) rotating the threaded bushing in the first rotational direction by a first predetermined rotational amount to further advance the threaded bushing a predetermined axial amount in the first axial direction beyond the point of contact so that the threaded bushing exerts a target preload on the bearing, (ii) rotating the threaded bushing in a second rotational direction that is opposite the first rotational direction by a second predetermined rotational amount to advance the threaded bushing in a second axial direction that is opposite the first axial direction a predetermined axial distance away from the point of contact to thereby create a target clearance between an axial end surface of the threaded bushing and the axial end surface of the flange portion of the bearing, or (iii) ceasing rotation of the threaded bushing, which may result in line-contact between the axial end surface of the threaded bushing and the axial end surface of the flange portion of the bearing.

### BRIEF DESCRIPTION OF THE DRAWINGS

FIG. 1 is a perspective view of one embodiment of a bearing assembly constructed in accordance with principles of the present disclosure.

FIG. 2 is a cross-sectional view of the bearing assembly illustrated in FIG. 1 with the threaded bushing removed.

FIG. 3 is a cross-sectional view of the bearing assembly of FIG. 1 where the bearing is set with a clearance.

FIG. 4 is a cross-sectional view of the bearing assembly of FIG. 1 where the bearing is set with a preload.

FIG. 5 is a cross-sectional view of another embodiment of a bearing assembly constructed in accordance with principles of the present disclosure.

FIG. 6 is a perspective view of another embodiment of a bearing assembly constructed in accordance with principles of the present disclosure.

FIG. 7 is a cross-sectional view of the bearing assembly illustrated in FIG. 6 with the threaded bushing removed.

FIG. 8 is a cross-sectional view of another embodiment of a bearing assembly constructed in accordance with principles of the present disclosure.

FIG. 9 is perspective view of another embodiment of a gear box constructed in accordance with principles of the present disclosure.

### DETAILED DESCRIPTION

Although the following text sets forth a detailed description of numerous different embodiments, the claims set forth at the end of this application are not limited to the disclosed embodiments. The detailed description is to be construed as exemplary only and does not describe every possible embodiment of the invention since describing every possible embodiment is impractical. Numerous alternative embodiments can be implemented, using either current technology or technology developed after the filing date of this application, which would still fall within the scope of the claims.

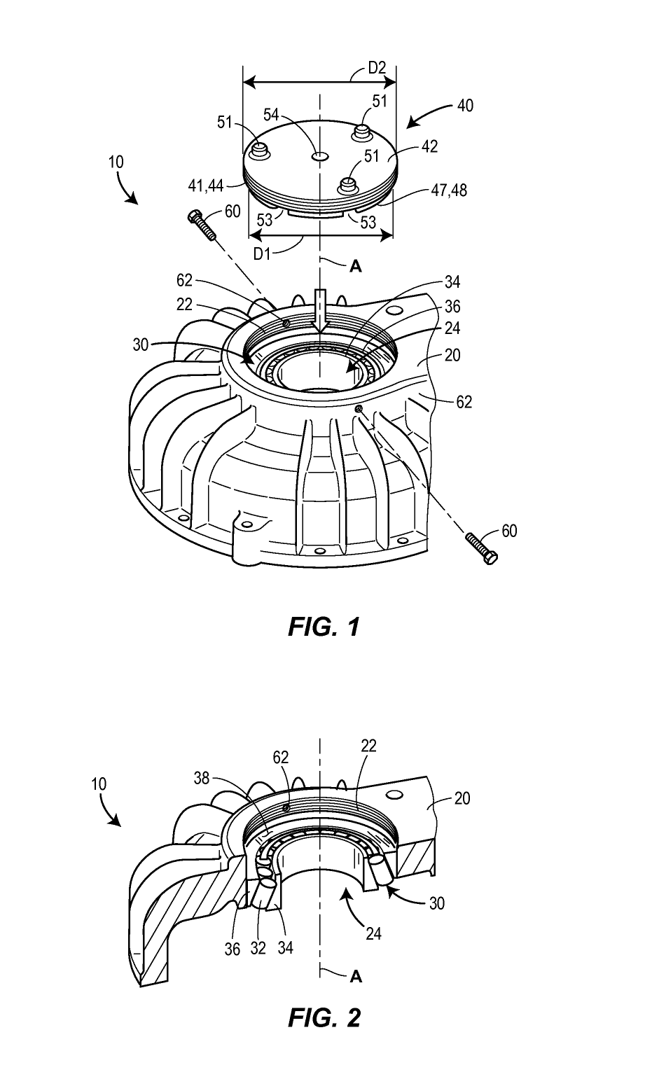

FIG. 1 depicts a perspective view of a bearing assembly 10, which can be used to set a target preload and/or clearance, in accordance with the principles of the present disclosure. The bearing assembly 10 may be implemented in various devices and systems having a rotating shaft, including, but not limited to, a gearbox, motor, pump, generator, steering mechanism, lathe, etc. The bearing assembly 10 includes a housing 20 having a threaded opening 22 that opens to the exterior of the housing 20 and which is in communication with a bearing cavity 24. The housing 20 may be formed as an integral component of the gearbox, motor, pump, generator, transmission, steering mechanism, lathe, etc. used in conjunction with the bearing assembly 10. The bearing cavity 24 houses a bearing 30 which is used to rotationally support a rotating shaft (not illustrated). The bearing 30 may be a tapered roller bearing, as illustrated in FIG. 2, or any other type of rolling-element bearing, such as a double row tapered roller bearing, cylindrical roller bearing, spherical roller bearing, ball bearing, etc. The bearing 30 includes a plurality of rollers 32 positioned between an inner race 34 and an outer race 36. During operation, the inner race 34 rotates together with the rotating shaft that may be disposed therethrough and the outer race 36 remains stationary, fixed in place on a radial shoulder (not shown) formed in the housing 20 and against which the outer race 36 axially seats.

Referring still to FIG. 1, the bearing assembly 10 includes a bushing 40 sized to threadably engage the threaded opening 22 of the housing 20. The threaded bushing 40 can be threadably advanced into the housing 20 in a first axial direction along an axis A by screwing the threaded bushing 40 into the threaded opening 22. The threaded bushing 40 can be threadably withdrawn from the housing 20 in an opposite, second axial direction along the axis A by unscrewing the threaded bushing 40 from the threaded opening 22. The axis A may correspond to the central axis of the bearing 30 and/or the rotational axis of the rotatable shaft supported by the bearing 30. The threaded bushing 40 includes a main body 42 and a flange portion 47. The main body 42 has a plurality of external threads 41 on an outer circumferential surface 44 and the flange portion 47 includes an axially extending annular flange 48 that protrudes from the main body 42. An axial end surface 52 of the axially extending annular flange 48 is configured to contact an axial end surface 38 of the outer race 36 of the bearing 30 when the axially extending annular flange 48 is advanced into the bearing cavity 24, as illustrated in FIG. 4. An outer diameter D1 of the axially extending annular flange 48 may be smaller than an outer diameter D2 of the main body 42 so that a lubricant pathway exists between the axially extending annular flange 48 and an interior wall of the housing 20. The axially extending annular flange 48 may also include a plurality of cut-outs 53 to promote the circulation of lubricant around the bearing 30.

As illustrated in FIG. 1, a plurality of protrusions 51 may extend from the outer surface of the main body 42 in a direction parallel to the axis A. The protrusions 51 may be gripped by a tool and/or by hand to rotate the threaded bushing 40.

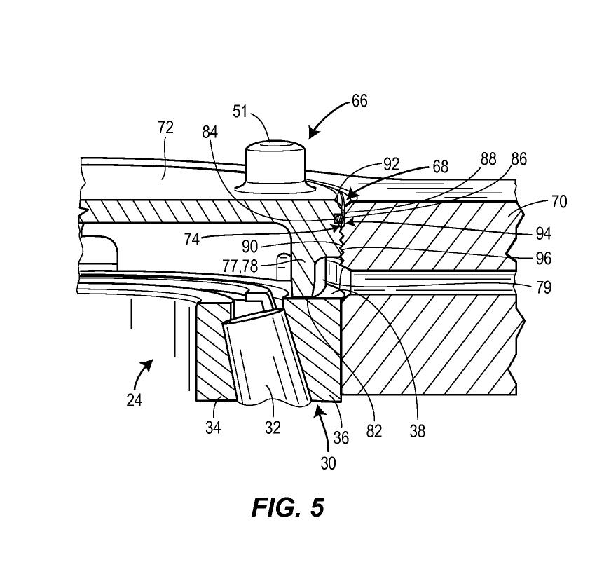

In the version depicted in FIGS. 1-4, the main body 42 and the axially extending annular flange 48 define, respectively, a closed end and an open end of the threaded bushing 40. Other embodiments can be arranged differently, for example, with the main body forming a second open end to allow a rotating shaft to extend outside of the housing, as described in more detail below in connection with FIGS. 5-7. The main body 42 of the present embodiment may be formed with a port 54.

To help prevent the threaded bushing 40 from becoming loosened during operation due to, for example, vibrations associated with the rotation of the rotatable shaft, the bearing assembly 10 may include one or more set screws 60 inserted through threaded openings 62 formed in the side of the housing 20. The set screws 60 and their respective openings 62 may extend in a direction substantially orthogonal to the axis A. When installed, distal ends of the set screws 60 press against the flange portion 47 and, in this embodiment an outer circumferential surface 49 of the axially extending annular flange 48, of the bushing 40 to frictionally prevent the bushing 40 from rotating. In addition to, or as an alternative to the set screws 60, an axial end portion (e.g., the rim) of the outer circumferential surface 44 of the main body 42 of the bushing 40 may be coated with an elastic material, such as rubber, that results in a tighter fit between the bushing 40 and the threaded opening 22 of the housing 20. Such an elastic material could provide a sufficient amount of friction to prevent unintended rotation of the bushing 40 when exposed to vibrations during use or otherwise.

The components of the bearing assembly 10 may be manufactured from any suitable material, including, but not limited to, metals, alloys, composites, ceramics, and/or plastic. In one embodiment, the housing 20 is manufactured from ASTM A48, class 30, gray cast iron.

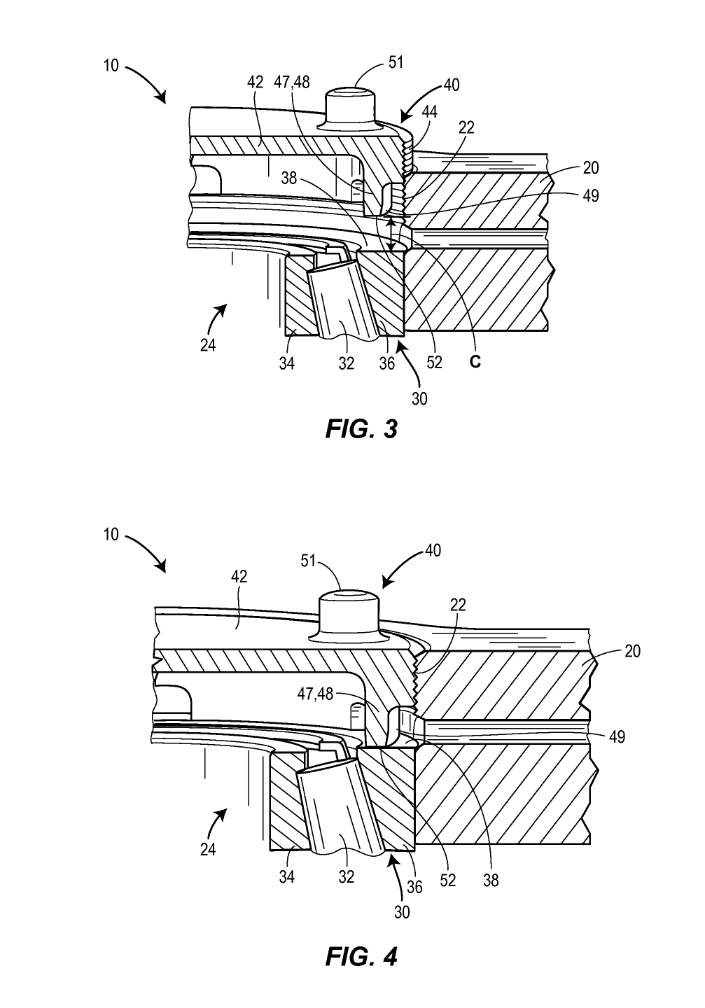

Referring to FIGS. 3 and 4, methods of using the threaded bushing 40 to set the bearing 30 with a target amount of preload or clearance, in accordance with principles of the present disclosure, will now be described. It should be understood that the term “preload,” as used herein, can be defined as the compressive force applied to the bearing 30 by the threaded bushing 40 or the distance by which the bearing 30 is compressed in the axial direction by the threaded bushing 40.

Looking to FIG. 3, this figure illustrates the bearing 30 set with a target amount of endplay or clearance C. It should be understood that FIG. 3 is intended for illustrative purposes only, and does not necessarily represent the true dimensions of the clearance C relative to other components of the bearing assembly 10. The clearance C is defined as the distance between the axial end surface 52 of the axially extending annular flange 48 of the bushing 40 and an axial end surface 38 of the outer race 36 of the bearing 30. The method begins with placing the bearing 30 within the bearing cavity 24 such that the outer race 36 resides on a shoulder that protrudes radially inwardly into the bearing cavity 24. This step may not always be necessary, if, for example, the bearing assembly 10 has been previously installed and the clearance C is simply being adjusted. Next, the threaded bushing 40 is aligned with the threaded opening 22 and screwed into the threaded opening 22 by rotating the threaded bushing 40 in a first rotational rotation direction (e.g., a clockwise direction when viewing the bushing 40 from the top of FIGS. 1-3), thereby causing the threaded bushing 40 to be advanced in a first direction along the axis A toward the bearing cavity 24. The threaded bushing 40 is rotated until the axial end surface 52 of the axially extending annular flange 48 makes initial contact with the axial end surface 38 of the outer race 36 of the bearing 30. For purposes of description, this initial contact can be referred to the “point of contact.” At this moment, rotation of the threaded bushing 40 in the first rotational direction is halted so that the threaded bushing 40 does not compress the bearing 30. Subsequently, the threaded bushing 40 is rotated in a second rotational direction (e.g., a counterclockwise direction when viewing the bushing 40 from the top of FIGS. 1-3) to withdraw the threaded bushing 40 along the axis A from the bearing cavity 24. That is, the bushing 40 is advanced in a second direction along the axis A that is opposite the first direction. The threaded bushing 40 is rotated in the second rotational direction by a predetermined rotational amount (e.g., a predetermined number of full or partial revolutions or a predetermined number of degrees). By rotating the threaded bushing 40 by the predetermined rotational amount, the threaded bushing 40 moves away from the bearing 30 a predetermined axial distance to create the target clearance C, as illustrated in FIG. 3. Methods of determining the predetermined axial distance and/or the predetermined rotational amount to achieve the target clearance are described below in more detail. After the target clearance C has been set, the set screws 60 may be inserted through their respective threaded openings 62, if not already present, and tightened into engagement with the outer circumferential surface 49 of the axially extending annular flange 48 to lock the threaded bushing 40 in place.

FIG. 4 depicts the bearing 30 set with a target amount of preload. Similar to the clearance procedure described above, the preload procedure may begin with positioning the bearing 30 inside the bearing cavity 24 (if this has not been done previously). The threaded bushing 40 is then aligned with the threaded opening 22 and screwed into the threaded opening 22 by rotating the threaded bushing 40 in the first rotational direction. This action causes the threaded bushing 40 to be advanced in the first axial direction along the axis A toward the bearing cavity 24. Rotation in the first rotational direction is continued until reaching the point of contact, i.e., the axial end surface 52 of the axially extending annular flange 48 of the threaded bushing 40 makes initial contact with the axial end surface 38 of the outer race 36 of the bearing 30 by pressing against the outer race 36 of the bearing 30. Rotation of the threaded bushing 40 can then be momentarily stopped. Subsequently, rotation of the threaded bushing 40 is resumed by rotating the threaded bushing 40 by a predetermined rotational amount in the first rotational direction. As a result, the threaded bushing 40 is further advanced in the first axial direction along the axis A and into the bearing cavity 24 to exert the target preload on the bearing 30. As mentioned above, the target preload may correspond to the desired compressive force to be applied to the bearing 30 or the distance by which it is sought to compress the bearing 30. In one embodiment, the target preload may correspond to approximately (e.g., ±10%) 0.005 inches, or lesser or greater, compression of the outer race 36 of the bearing 30 in the axial direction. Methods of determining a predetermined rotational amount for the target preload are described below in more detail. Once the target preload has been set, the set screws 60 may be inserted through their respective threaded openings 62, if not already present, and tightened into engagement with the outer circumferential surface 49 of the axially extending annular flange 48 to prevent further rotation of the threaded bushing 40.

Several different techniques can be used to determine the amount of rotation necessary to set the bearing 30 with the target clearance or preload. The amount of axial movement of the threaded bushing 40 caused by rotating the threaded bushing 40 is dependent upon the thread pitch of the threaded bushing 40 (i.e., the distance between crests of the thread). Accordingly, knowledge of the thread pitch can be used to calculate how many turns or partial turns of the threaded bushing 40 are needed to create the target clearance C between the threaded bushing 40 and the bearing 30. Similarly, the thread pitch can be used to determine how many turns or partial turns of the threaded bushing 40 are necessary to axially advance the threaded bushing to compress the outer race 36 of the bearing 30 by a predetermined axial distance. Accordingly, the thread pitch can be used to calculate the amount of rotation of the threaded bushing 40 necessary to set the target preload.

The amount of rotation needed to set the threaded bushing 40 with the target clearance or preload can also be determined by reference to a table, plot, graph and/or data structure that associates each of a plurality of target clearance and/or preload values with a respective rotational amount of the threaded bushing 40. For example, such a table, plot, graph and/or data structure may indicate that two full rotations of the threaded bushing results in 0.005 inches of axial movement of the threaded bushing and, in the case of preloading, results in 25 N of force being applied to the bearing. Referencing such a table, plot, graph and/or data structure frees the technician tasked with setting the bearing from having to calculate the axial movement of the threaded bushing 40 based on the thread pitch. The technician may be able to retrieve the predetermined rotational amount from a portable computer carried by the technician (e.g., a smartphone or a handheld diagnostic device) that is able to access a data structure that associates a plurality of target clearance and/or preload values with respective rotational amounts of the threaded bushing 40.

To determine the target clearance or preload that is suitable for a particular bearing, a specification manual published by the manufacturer of the bearing may be used. Such a specification manual may indicate the target clearance or preload associated with various operating conditions (e.g., temperature, shaft speed, lubricant, etc.).

Once an attempt has been made to set the threaded bushing 40 with a target amount of clearance or preload, a measuring tool (e.g., a dial indicator, calipers, and/or a strain gauge) may be inserted through the port 54 to confirm whether or not the actual clearance or preload corresponds to the target amount clearance or preload. In some embodiments, prior to rotating the threaded bushing 40 into a preload state, a measuring tool may be inserted through the port 54 to check the amount of clearance.

In some embodiments, after the threaded bushing 40 makes initial contact with the axial end surface 38 of the outer race 36 of the bearing 30, the threaded bushing 40 may not be further rotated. Accordingly, the outer race 36 of the bearing 30 may neither be preloaded nor provided with clearance. Rather, the threaded bushing 40 forms line-contact with the outer race 36 of the bearing 30.

FIG. 5 illustrates another version of the threaded bushing (threaded bushing 66), which inhibits or prevents fluid ingress and/or egress through the interface between the threaded bushing 66 and an opening 68 of a housing 70. The threaded bushing 66 may include many of the same features as the threaded bushing 40, including a main body 72 and a flange portion 77. The main body 72 may have an outer circumferential surface 74. The flange portion 77 may include an axially extending annular flange 78 that protrudes from the main body 72, an outer circumferential surface 79, and an axial end surface 82.

The threaded bushing 66 differs from the threaded bushing 40 in that the outer circumferential surface 74 of the main body 72 may include an annular groove 84 for retaining an annular sealing member 86 (e.g., an elastomeric O-ring). The annular sealing member 86 may be arranged in the annular groove 84 prior to advancing the threaded bushing 66 in the first direction along the axis A into the opening 68 of the housing 70. The annular groove 84 may be formed in a first portion 88 of the outer circumferential surface 74 which is not threaded. A second portion 90 of the outer circumferential surface 74 may be threaded to facilitate the preloading and clearance methods described above. A first portion 92 of an inner wall 94 of the opening 68 that is positioned in opposition to the first portion 88 of the outer circumferential surface 74 may not be threaded, and a second portion 96 of the inner wall 94 of the opening 68 that is positioned in opposition to the second portion 90 of the outer circumferential surface 74 may be threaded. In an alternative embodiment (not illustrated), the annular groove for retaining the annular sealing member 86 may be formed in the first portion 92 of the inner wall 94 of the opening 68.

As illustrated in FIG. 5, the annular sealing member 86 presses against and sealingly engages the first portion 92 of the inner wall 94 of the opening 68 when the threaded bushing 66 is advanced into the opening 68. Accordingly, a seal is formed between the threaded bushing 66 and the opening 68 that inhibits or prevents the ingress and/or egress of fluid through the interface between the threaded bushing 66 and the opening 68. This configuration may be advantageous in applications where the threaded bushing 66 is exposed to environmental elements such as rain, sleet, snow, ice, humidity, dirt, and other contaminants that may potentially seep into the opening 68 and corrode, or otherwise damage, one or more of the threads on threaded bushing 66 or the threads associated with the opening 68. Such damage, which may take the form of rust, can make it difficult to rotate the threaded bushing 66, which in turn impedes the ability to set the bearing 30 with a target amount of preload and/or clearance. The inclusion of the annular sealing member 86 helps reduce the likelihood of such damage, thereby rendering the threaded bushing 66 suitable for outdoor applications, such as, for example, an air cooled condenser.

Setting the threaded bushing 66 with a target preload or a target clearance may be accomplished in a similar manner as the threaded bearing 40 discussed above.

While FIG. 5 depicts the threaded bushing 66 as being used to preload the bearing 30, the threaded bushing 66 may also be used to set the bearing 30 with a target clearance, similar to the illustration in FIG. 3. In one embodiment, the annular groove 84 and the annular sealing member 86 may be positioned along the outer circumferential surface 74 such that, when the threaded bushing 66 is used to provide clearance, the annular sealing member 86 presses against and sealingly engages the first portion 92 of the inner wall 94 of the opening 68. Thus, the annular sealing member 86 may perform its sealing function in the preloading context as well as the clearance context.

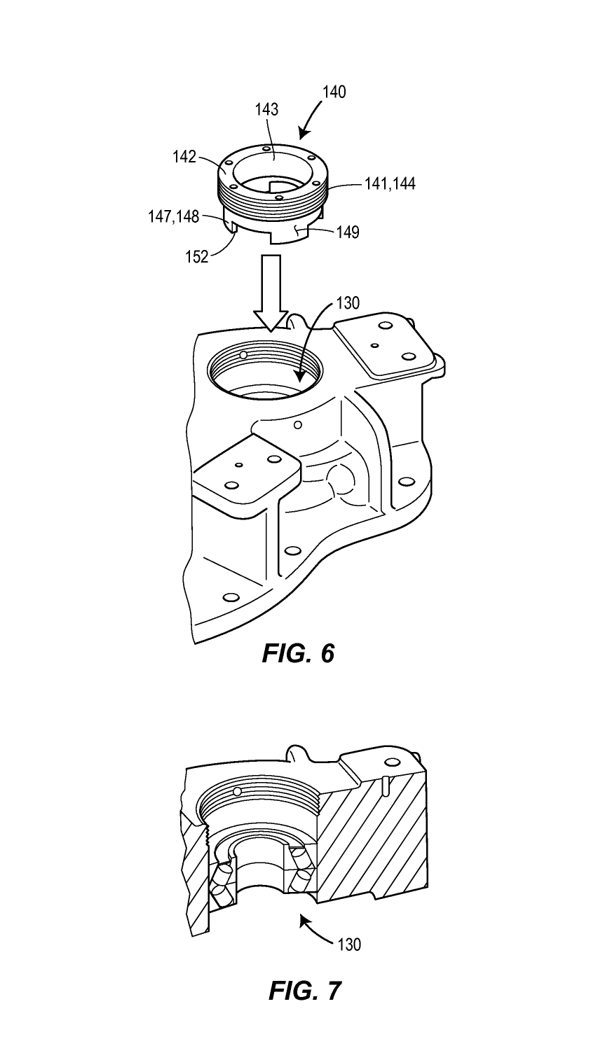

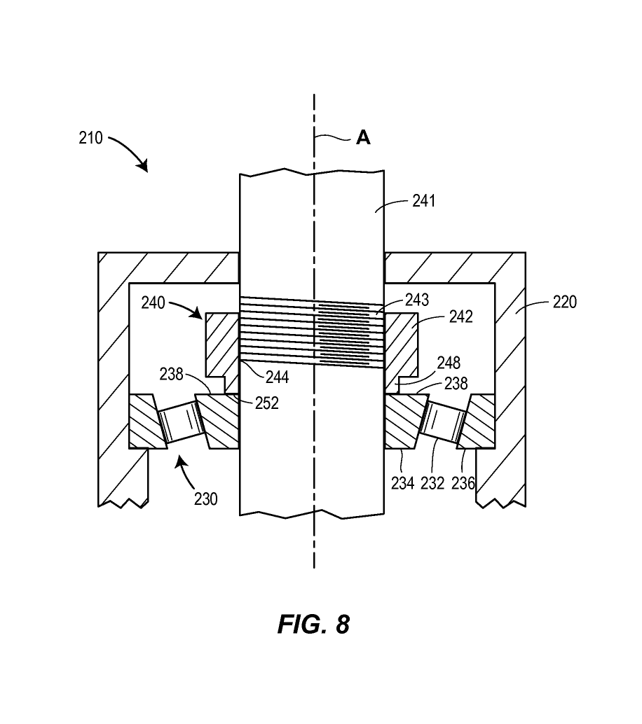

FIG. 6 illustrates yet another version of the threaded bushing (threaded bushing 140) which allows the rotatable shaft to extend outside of the bearing housing. The threaded bushing 140 includes many of the same features as the threaded bushing 40 such as a main body 142 and a flange portion 147. The main body 142 has a threaded outer circumferential surface 144 with a plurality of external threads 141. The flange portion 147 includes an axially extending annular flange 148 that protrudes from the main body 142, an axial end surface 152, and an outer circumferential surface 149. The threaded bushing 140 differs from the threaded bushing 40 in that the main body 142 includes an opening 143 sized to permit a rotatable shaft to pass through the threaded bushing 140. This configuration is useful when the threaded bushing 140 is used to set a bearing associated with the input and/or output shaft of a gearbox. It may be necessary for the input and/or output shaft to extend outside the gearbox housing to operatively connect to an external component such as a motor and/or a rotationally-driven mechanism such as a turbine or other device. Furthermore, the threaded bushing 140 may be used in conjunction with a double row tapered roller bearing, such as the double row tapered roller bearing 130 illustrated in FIG. 7, or any other type of rolling-element bearing including a tapered roller bearing, cylindrical roller bearing, spherical roller bearing, ball bearing, etc. Setting the threaded bushing 140 with a target preload or a target clearance may be accomplished in a similar manner as the threaded bearing 40 discussed above. Additionally, the threaded bushing 140 may incorporate an annular groove and an annular sealing member (e.g., an elastomeric O-ring) in a similar manner as the threaded bushing 66 described above.

While the foregoing embodiments are configured to set the bearing by exerting pressure on the outer race of the bearing or by providing the outer race of the bearing with a clearance, the scope of the present disclosure is not limited to setting the bearing in this manner. Rather, alternative embodiments can be arranged to set the bearing by applying pressure to the inner race of the bearing or by providing the inner race of the bearing with a clearance. FIG. 8 illustrates a bearing assembly 210 including a housing 220, a bearing 230 including rollers 232 positioned between an inner race 234 and an outer race 236, and a threaded bushing 240 threadably engaged to a rotatable shaft 241. In one embodiment, the threaded bushing 240 is configured as a lock nut. The rotatable shaft 241 illustrated in FIG. 8 is configured as an input shaft. However, in alternative embodiments, the rotatable shaft 241 may be configured as an intermediary shaft or an output shaft. The threaded bushing 240 and the inner race 234 of the bearing 230 rotate together with the rotatable shaft. The threaded bushing 240 includes a main body 242 having a threaded inner circumferential surface 244 configured to threadably engage a threaded outer circumferential surface 243 of the rotatable shaft 241, as well as, an axially extending annular flange 248 that protrudes from the main body 242. An axial end surface 252 of the axially extending annular flange 248 is configured to contact the inner race 234 of the bearing 230 when the threaded bushing 240 is screwed past a certain point on the rotatable shaft 241. To help prevent the threaded bushing 240 from becoming loosened during operation due to, for example, rotational forces and/or vibrations, an axial end portion (e.g., the rim) of the inner circumferential surface 244 of the main body 242 of the threaded bushing 240 may be coated with an elastic material, such as rubber, that results in a tighter fit between the threaded bushing 240 and the rotatable shaft 241.

To set the bearing 230 with a target amount of clearance, the threaded bushing 240 is screwed onto the threaded outer circumferential surface 243 of the rotatable shaft 241 by rotating the threaded bushing 240 in a first rotational rotation direction (e.g., a clockwise direction when viewing the device of FIG. 8 from the top), thereby causing the threaded bushing 240 to be advanced in a first axial direction along the axis A toward the bearing 230. The threaded bushing 240 is rotated until the axial end surface 252 of the axially extending annular flange 248 makes initial contact with the axial end surface 238 of the inner race 236 of the bearing 230. For descriptive purposes, this can be referred to as the “point of contact.” Subsequently, rotation of the threaded bushing 240 in the first rotational direction is stopped so that the threaded bushing 240 does not compress the bearing 230. Next, the threaded bushing 240 is rotated in a second rotational direction (e.g., a counterclockwise direction when viewing the device of FIG. 8 from the top) to withdraw the threaded bushing 240 in a second axial direction that is opposite the first axial direction along the axis A away from the bearing 230. The threaded bushing 240 is rotated in the second rotational direction by a predetermined rotational amount (e.g., a predetermined number of full or partial revolutions or a predetermined number of degrees). As a result of this rotation, the threaded bushing 240 moves away from the bearing 230, thereby creating the target clearance.

The bearing 230 of FIG. 8 is set with a target amount of preload by screwing the threaded bushing 240 onto the threaded outer circumferential surface 243 of the rotatable shaft 241 in the first rotational direction until reaching the “point of contact,” i.e., the axial end surface 252 of the axially extending annular flange 248 of the threaded bushing 240 makes initial contact with the axial end surface 238 of the inner race 236 of the bearing 230. Rotation of the threaded bushing 240 in the first rotational direction can then be momentarily stopped. Subsequently, rotation of the threaded bushing 240 is resumed by rotating the threaded bushing 240 by a predetermined rotational amount in the first rotational direction. Consequently, the threaded bushing 240 is further advanced in the first axial direction toward the bearing 230 and exerts the target preload on the threaded bushing 240 by pressing against the inner race 236 of the threaded bushing 240. The target preload may correspond to the desired compressive force to be applied to the threaded bushing 240 or the distance by which it is sought to compress the threaded bushing 240.

The determination of the predetermined rotational amount necessary for setting the target clearance or the target preload can be performed in the manner discussed above, for example, by using the thread pitch of the threaded bushing 240 to calculate how much axial movement of the threaded bushing 240 will result from rotating the threaded bushing 240, and/or by referencing a table, plot, graph and/or data structure that associates each of a plurality of target clearance and/or target preload values with a respective rotational amount.

In embodiments where the inner race 234 of the bearing 230 forms an interference fit with the rotatable shaft 241, if the threaded bushing 240 is used to initially preload the inner race 234 of the bearing 230, subsequently backing off the threaded bushing 240 by rotating it in the second rotational direction may do little, or nothing, to relieve the internal pressure of the bearing 230. This is because the position of the inner race 234 of the bearing 240 relative to the rotatable shaft 241 may be fixed as a result of the interference fit.

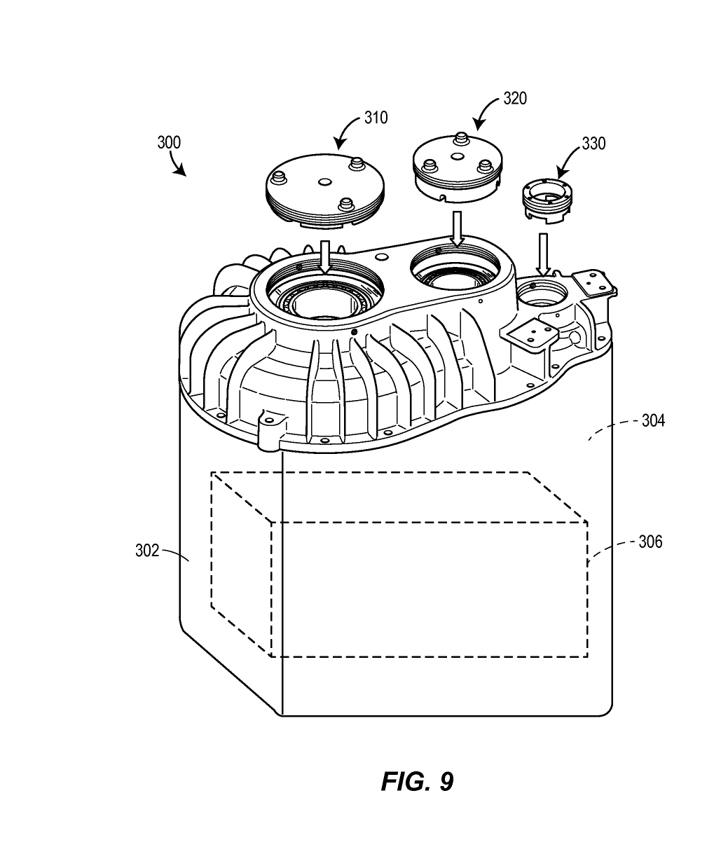

FIG. 9 illustrates a gear box 300 including a housing 302 having a hollow interior defining a gearbox cavity 304. A gear set 306 is positioned within the gearbox cavity 304 and includes three rotatable shafts (not shown) which are rotatably supported by, respectively, bearing assemblies 310, 320, 330. The bearing assemblies 310 and 320 may each incorporate the threaded bushing 40 depicted in FIGS. 1-4, and the bearing assembly 330 may incorporate the threaded bushing 140 illustrated in FIG. 6. Alternatively, one or more of the bearing assemblies 310, 320, 330 may incorporate the threaded bushing 66 illustrated in FIG. 5 or the threaded bushing 240 illustrated in FIG. 8. An input shaft or an output shaft of the gearbox 300 may be arranged to extend through the bearing assembly 330 and to the exterior of the gear box housing 302. The threaded bushings associated with the bearing assemblies 310, 320, 330 may be set with a target preload and/or clearance in a manner similar to that discussed above.

The foregoing threaded bushings and methods of setting of a bearing with preload and/or clearance can be implemented in a variety of applications and settings. The threaded bushings can be used set the bearing(s) of a gear box associated with (e.g., transfers torque to) a cooling tower fan, a turbine, or a pump such as an irrigation pump, a fire water protection pump, and a flood control pump, or a vertical turbine pump, among other rotating devices. In one embodiment, the threaded bushing can be used to set the bearing of a gearbox of a cooling tower fan sold by Hudson Products Corporation. The pumping applications in which the threaded bushing is capable of use can operate in the range of approximately (e.g., ±10%) 30-1000 HP, or lesser or greater. Also, the threaded bushing can be used in conjunction with a bearing that supports a shaft rotating at speeds in the range of approximately (e.g., ±10%) 1000-3000 revolutions per minute (rpm), or 200-400 rpm, or 50-100 rpm, or lesser or greater.

From the foregoing, it can been seen that the present disclosure advantageously provides improved methods and devices for setting a bearing in a manner that is more efficient than conventional techniques and which does not require the use of physical aids such as shims. These aspects are particularly beneficial in the context of field adjustment of the clearance and/or preload where access to the bearing may be limited. Furthermore, the target clearance and/or preload can be set relatively precisely, in part because the relationship between rotation of the threaded bushing and the axial advancement of the threaded bushing is typically predictable.

While the present disclosure has been described with respect to certain embodiments, it will be understood that variations may be made thereto that are still within the scope of the appended claims.

1. A method of assembling a bearing within a housing, the housing having a threaded opening and a bearing cavity, the method comprising:
positioning the bearing within the bearing cavity;
advancing a threaded bushing in an axial direction into the threaded opening of the housing by rotating the threaded bushing in a first rotational direction such that a flange portion of the threaded bushing extends at least partly into the bearing cavity;
identifying a point of contact when the flange portion of the threaded bushing initially contacts the bearing in the bearing cavity; and
rotating the threaded bushing in the first rotational direction by a predetermined rotational amount to further advance the threaded bushing in the axial direction a predetermined axial distance beyond the point of contact so that the flange portion of the threaded bushing exerts a target preload on the bearing.

2. The method of claim 1, comprising determining the predetermined rotational amount by referencing a table, plot, graph and/or data structure associating each of a plurality of target preload values with a respective rotational amount.

3. The method of claim 1, comprising determining the predetermined rotational amount based on at least one of: (i) the target preload, (ii) the predetermined axial distance, and (iii) a thread pitch associated with the threaded bushing.

4. The method of claim 1, wherein the flange portion of the threaded bushing includes an axially extending annular flange extending from a main body, the main body having a plurality of external threads, the axially extending annular flange having a smaller outer diameter than the main body.

5. The method of claim 4, wherein, at the point of contact, an axial end face of the axially extending annular flange of the threaded bushing contacts an axial end face of an outer race of the bearing in the bearing cavity.

6. The method of claim 4, comprising screwing a set screw through a second threaded opening in the housing and into engagement with the flange portion of the threaded bushing to prevent further rotation of the threaded bushing.

7. The method of claim 1, comprising engaging the threaded bushing with a tool and using the tool for rotating the threaded bushing in the first rotational direction.

8. The method of claim 1, comprising inserting a rotatable shaft through the threaded bushing and the bearing.

9. A method of assembling a bearing within a housing, the housing having a threaded opening and a bearing cavity, the method comprising:
positioning the bearing within the bearing cavity;
advancing a threaded bushing in a first axial direction into the threaded opening of the housing by rotating the threaded bushing in a first rotational direction such that a flange portion of the threaded bushing extends at least partly into the bearing cavity;
identifying a point of contact when the flange portion of the threaded bushing initially contacts the bearing in the bearing cavity; and
rotating the threaded bushing in a second rotational direction that is opposite the first rotational direction by a predetermined rotational amount to advance the threaded bushing in a second axial direction that is opposite the first axial direction a predetermined axial distance away from the point of contact to thereby create a target clearance between an axial end surface of the threaded bushing and an axial end surface of the flange portion of the bearing.

10. The method of claim 9, comprising determining the predetermined rotational amount by referencing a table, plot, graph and/or data structure associating each of a plurality of target clearance values with a respective rotational amount.

11. The method of claim 9, comprising determining the predetermined rotational amount based on at least one of: (i) the target clearance, (ii) the predetermined axial distance, and (iii) a thread pitch associated with the threaded bushing.

12. The method of claim 9, wherein the flange portion of the threaded bushing includes an axially extending annular flange extending from a main body, the main body having a plurality of external threads, the axially extending annular flange having a smaller outer diameter than the main body.

13. The method of claim 12, comprising screwing a set screw through a second threaded opening in the housing and into engagement with the axially flange portion of the threaded bushing to prevent further rotation of the threaded bushing.

14. The method of claim 9, comprising engaging the threaded bushing with a tool and using the tool for rotating the threaded bushing in the first and second rotational directions.

15. The method of claim 9, comprising inserting a rotatable shaft through the threaded bushing and the bearing.

16. A method of setting a bearing within a bearing cavity of a gear box housing that defines a gear box cavity containing a gear set, the housing having an opening in communication with the bearing cavity, the bearing cavity being positioned between the opening and the gear box cavity, the method comprising:
advancing a threaded bushing in a first axial direction toward the gear box cavity by rotating the threaded bushing in a first rotational direction until reaching a point of contact between an axial end surface of a flange portion of the threaded bushing and the bearing; and
after reaching the point of contact, either:
(i) rotating the threaded bushing in the first rotational direction by a first predetermined rotational amount to further advance the threaded bushing a predetermined axial amount in the first axial direction beyond the point of contact so that the threaded bushing exerts a target preload on the bearing,
(ii) rotating the threaded bushing in a second rotational direction that is opposite the first rotational direction by a second predetermined rotational amount to advance the threaded bushing in a second axial direction that is opposite the first axial direction a predetermined axial distance away from the point of contact to thereby create a target clearance between an axial end surface of the threaded bushing and the axial end surface of the flange portion of the bearing; or
(iii) ceasing rotation of the threaded bushing.

17. The method of claim 16, comprising determining:
(i) the first predetermined rotational amount by referencing a first table, plot, graph and/or data structure associating each of a plurality of target preload values with a respective rotational amount; or
(ii) the second predetermined rotational amount by referencing a second table, plot, graph and/or data structure associating each of a plurality of target clearance values with a respective rotational amount.

18. The method of claim 16, comprising determining:
(i) the first predetermined rotational amount based on at least one of: (a) the target clearance, (b) the predetermined axial distance, and (c) a thread pitch associated with the threaded bushing; or
(ii) the second predetermined rotational amount based on at least one of: (a) the target clearance, (b) the predetermined axial distance, and (c) a thread pitch associated with the threaded bushing.

19. The method of claim 16, the opening in the housing having a threaded inner circumferential surface and the threaded bushing having a threaded outer circumferential surface configured to threadably engage the threaded inner circumferential surface of the opening.

20. The method of claim 19, the gear set including a rotatable shaft having a threaded outer circumferential surface and the threaded bushing having a threaded inner circumferential surface configured to threadably engage the threaded outer circumferential surface of the rotatable shaft.

21. The method of claim 16, comprising arranging an annular sealing member in an annular groove formed in an outer circumferential surface of the threaded bushing prior to advancing the threaded bushing in the first axial direction into the opening of the housing.
